(19) United States
(12) Patent Application Publication
(10) Pub. No.: US 2002/0043884 A1
(43) Pub. Date: Apr. 18, 2002

(54) Electrical vehicle motor

(76) Inventor: John C. Hunter, Cedar Glen, CA (US)

Correspondence Address: Richard C. Litman, LITMAN LAW OFFICES, LTD., P.O. Box 15035, Arlington, VA, 22215, US

(21) Appl. No.: 09/978,049

(22) Filed: Oct. 17, 2001

Related U.S. Application Data
(60) Provisional application No. 60/240,989, filed on Oct. 18, 2000.

(51) Int. Cl. H02K 7/02

(52) U.S. Cl. 310/74; 180/165

(57) ABSTRACT

A flywheel-type battery is integrated within a motor useful for maintaining a flywheel at a constant speed when actuated. It provides an FBEV motor wherein the rotor windings are located on the interior and exterior of the peripherally mounted battery, making the battery casing, itself, the driving force of the motor. The battery housing also supports stator windings that are used in the operation of the motor. The drive train adjusts the torque to the wheels by hydraulics. A computer changes the motor into a generator upon slowing, stopping, or going downhill, which recharges the battery, increasing range. A large number of stator coils, mounted on the housing, and rotor coils mounted on the inner and outer wall of the peripheral battery, may each be separately energized by means of a computer to maintain the flywheel at a constant high speed, once the motor is actuated. This makes maximum torque available to the vehicle at any time for sudden acceleration.

### CROSS-REFERENCE TO RELATED APPLICATION

This application claims the benefit of U.S. Provisional Patent Application Serial No. 60/240,989, filed Oct. 18, 2000.

### BACKGROUND OF THE INVENTION

1. Field of the Invention

The present invention relates to an electric driven vehicle and, more particularly, a vehicle which relies on a flywheel as an energy source, and still more particularly, to a flywheel-driven vehicle in which the flywheel contains batteries and acts as an electric motor.

2. Description of Related Art

In conventional electrical vehicles (EV)s, range of travel is limited due to the inefficiency, size, and weight of the battery or batteries. The motor and the battery are separate components. This is true even in flywheel battery electrical vehicles (FBEV)s.

U.S. Pat. No. 5,427,194, issued on Jun. 27, 1995, to E. L. Miller describes a flywheel with electric batteries mounted thereon for an electrical vehicle. Provision is made for maintaining balance of the flywheel through movable weights and magnetic suspension of the flywheel axle. A separate motor and a separate generator are provided along the flywheel supporting and rotating shaft. The present invention avoids the weight of the electric motor and generator by incorporating the motor into the rotating flywheel and its casing, which also serves as a generator when the vehicle descends a hill, thus avoiding the extra weight of a separate motor and generator.

U.S. Pat. No. 5,212,026, issued on May 18, 1993, to D. E. Mitchell, describes a combination battery and flywheel for an EV, wherein a novel stacked multiple battery flywheel is employed. Separate electric motors are employed in this system, adding significant weight which is not part of the rotating wheel. In the present invention separate motors are not used, but the flywheel serves as part of an electric motor, thus, saving weight.

U.S. Pat. No. 4,140,916, issued on Feb. 20, 1979, to Yum describes a battery-containing flywheel for an EV which employs a separate driving motor driving the flywheel shaft. In the present invention separate motors are not used but the flywheel serves as part of an electric motor, thus saving weight. The present invention integrates a flywheel battery and motor into a single unit, thus saving considerable weight while making maximum torque available at all times.

U.S. Pat. No. 3,497,026, issued on Feb. 24, 1970 to W. L. Calvert describes an electrical power system for an EV employing a battery-containing flywheel shaft which provides field poles on the inner side of the flywheel as part of an electric motor-generator. A variable ratio transmission employs a lower inner portion of the flywheel acting on a radially movable friction wheel. An armature is axially located with respect to the battery-containing flywheel so as to electromagnetically interact with the field poles located on the flywheel so as to act as a generator or use electrical power as a motor. A mechanical feedback system maintains the armature at a desired speed of rotation differing from the field poles mounted on the flywheel so as to slowly generate electric power to the batteries or slowly accelerate the flywheel to avoid overly rapid charging or discharging of the batteries. The present invention employs rotor field poles or windings on both the inner and outer surfaces of the battery of the battery-flywheel which electromagnetically interact with stator windings located on the housing and the removable cover of the housing. A constant flywheel speed is maintained during operation of the computer by selectively energizing rotor field windings and stator windings as controlled by a computer, voltage input to the windings remains constant. This is desirable in order to make maximum torque available to the FBEV upon demand. Whenever the vehicle slows, stops or is going downhill, the computer changes the rotor to an alternator and recharges the battery.

UK Patent No. G.B. 2 255 152 A, published Oct. 28, 1992, also describes an electrical power system for an EV employing a battery-containing flywheel shaft which provides field poles acting as a rotor on the inner side of the flywheel as part of an electric motor-generator. The stator windings are located inboard of the flywheel-mounted field poles. The flywheel is allowed to operate at various revolution speeds and may increase its speed during vehicle deceleration or descent. A large number of stator coils and rotor coils may each be selectively energized by means of a computer to maintain the flywheel at a constant high speed, once the motor is actuated. A constant flywheel speed is desirable in order to assure full vehicle acceleration power at any time is available. Whenever the vehicle slows, stops or is going downhill, the computer changes the rotor to an alternator and recharges the battery.

German Patent No. DE19502960 published Aug. 1, 1996, UK Patent No. G.B. 2 128 946, published May 10, 1984, and German Patent No. 2,237,896 published Feb. 14, 1974, are cited but each employs an electric motor separate from the battery-flywheel. None of the above inventions and patents, taken either singly or in combination, is seen to describe the instant invention as claimed.

### SUMMARY OF THE INVENTION

The present invention provides a flywheel-type battery which is integrated within a motor useful for maintaining the flywheel at a constant speed when actuated. It is composed of three major structures: an outer housing having a cylindrical housing wall and bottom section located at the base of the cylindrical casing which supports an axially located bearing; a flywheel-battery having an axle and a rotor having a battery supported about its periphery and connected to the axle by flanges so oriented as to form a fan for movement of cooling air through the system; and a housing lid having a cylindrical wall depending therefrom and upper radial flanges to support and axially locate the bearing for the rotor axle.

The cylindrical wall of the housing lid is configured to fit within the inner wall of the peripheral battery of the battery-rotor. Rotor windings are located along the interior and exterior walls of the battery, making the battery casing, itself, the driving force of the motor. These windings are used to recharge the battery when the vehicle is in a condition of negative drive force (stopping, slowing down, and going downhill). The drive train adjusts the torque to the wheels as needed through a series of hydraulics similar to a conventional transmission, except upon slowing, stopping, or going downhill, the torque is sent back into the motor to turn it, by means of a computer, into a generator which will recharge the battery.

The FBEV motor of the present invention utilizes smaller, more efficient rotor coils than are currently being used in EV electric motors, but requires a greater number of them. It also requires smaller stator coils. A large number of stator coils and rotor coils may each be selectively energized by means of a computer to maintain the flywheel at a constant high speed, once the motor is actuated. This is desirable in order to make maximum torque available to the vehicle at any time for sudden acceleration. A hydraulic transmission system is driven by the axle of the flywheel to convert torque from the constant speed flywheel to desired vehicle motion, a feedback system, computer actuated, being available upon vehicle stopping, deceleration or descent to turn the flywheel motor to a power generator for recharging the rotating battery system.

Accordingly, it is a principal object of the invention to provide a new and improved electro-hydraulic driven vehicle which overcomes the disadvantages of the prior art in a simple but an effective manner.

It is another object of the invention to provide a battery flywheel for an electro-hydraulic driven vehicle which may be easily and efficiently manufactured and marketed.

It is a further object of the invention to provide a new and improved flywheel battery for an electro-hydraulic vehicle which is of durable and reliable construction.

It is still another object of the invention to provide a battery flywheel which is maintained at a high, essentially constant speed of rotation by a computerized control system.

It is yet another object of the invention to provide a high speed battery flywheel having an axle providing torque to a hydraulic transmission.

It is still another object of the invention to provide a high speed battery flywheel wherein the battery is located around the periphery of the flywheel and connected to the rotating axle by radial struts so designed and oriented as to move cooling air through the flywheel housing.

It is yet another object of the invention to provide a plurality of relatively small rotor coils along the outer and inner walls of the peripheral battery and a plurality of relatively small stator coils along the inner wall of the conforming flywheel housing and the inner wall of the conforming flywheel cover so as to provide a motor-generator therefrom.

It is still another object of the invention to provide a computer controlled system to activate individual rotor and stator coils as required to develop and maintain the constant high speed of rotation of said battery flywheel motor-generator.

It is yet another object of the invention to provide a computer controlled system for turning said motor-generator from electric motor operating mode upon vehicle acceleration to electric generator mode upon vehicle deceleration or descent.

It is still another object of the invention to provide a constant high-speed battery flywheel capable of providing maximum torque at any time for sudden acceleration of the vehicle upon demand.

It is yet another object of the invention to provide a battery flywheel motor-generator which minimizes EMF interference with other vehicles and radio and communication equipment.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a diagrammatic, environmental, perspective view of an electrical vehicle motor housing according to the present invention.

FIG. 2 is a diagrammatic elevation view of the electrical vehicle motor housing of FIG. 1.

FIG. 3 is a diagrammatic plan view of the battery-flywheel of FIG. 2 showing inner and outer rotor windings.

FIG. 4 is a diagrammatic elevation view of the battery-flywheel of FIG. 3 further depicting outer rotor windings.

FIG. 5 is a diagrammatic plan view of the peripherally mounted battery of FIG. 2.

FIG. 6 is a diagrammatic section view drawn along line 6A-6A of the battery of FIG. 5, and including the battery support.

FIG. 7 is a diagrammatic perspective view of the exterior stator housing showing outer stator windings.

FIG. 8 is a diagrammatic bottom view of the stator housing top assembly showing inner stator windings of FIG. 1.

FIG. 9 is a diagrammatic elevation view of the stator housing top assembly of FIG. 8 showing inner stator windings.

FIG. 10 is a diagrammatic detail view of a typical rotor winding coil and support of FIGS. 4 and 9.

FIG. 11 is a side view in elevation of the rotor winding coil cleat of FIG. 10, absent the coil itself.

Similar reference characters denote corresponding features consistently throughout the attached drawings.

### DETAILED DESCRIPTION OF THE PREFERRED EMBODIMENTS

The present invention overcomes the drawbacks of conventional EV's, i.e., range of travel is limited due to the inefficiency, size, and weight of the battery or batteries, and the motor and the battery being separate components. The present invention provides a flywheel-type battery which is integrated within the motor within a lower housing and a housing lid. It provides an FBEV motor wherein the rotor windings are located on the interior and exterior of the peripherally mounted battery relative to the plane of the flywheel, making the battery, itself, in consort with the housing, the driving force of the motor.

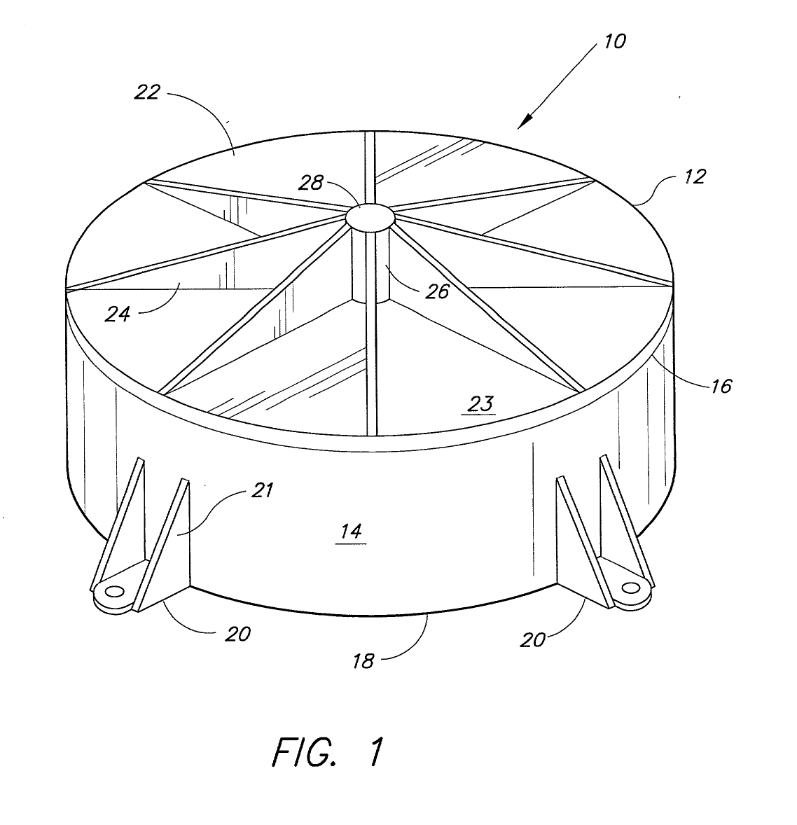

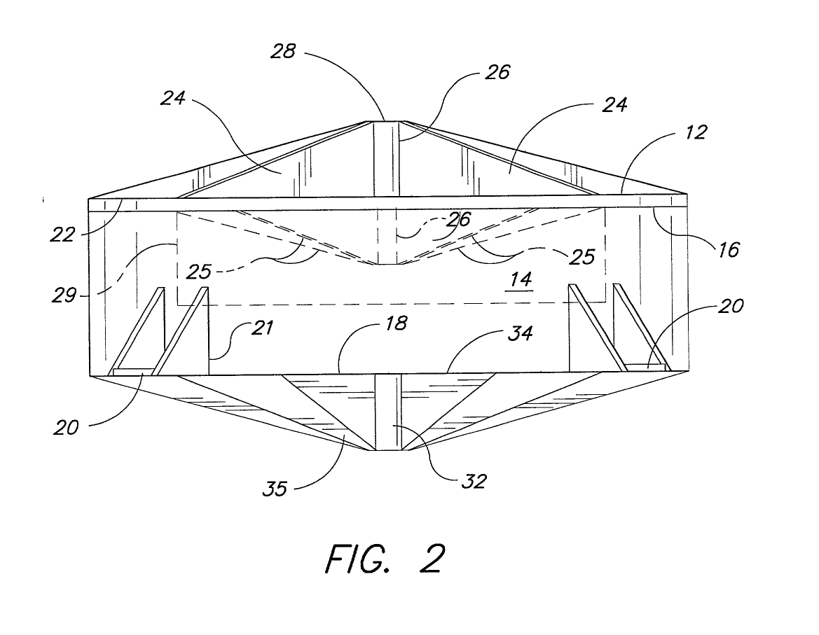

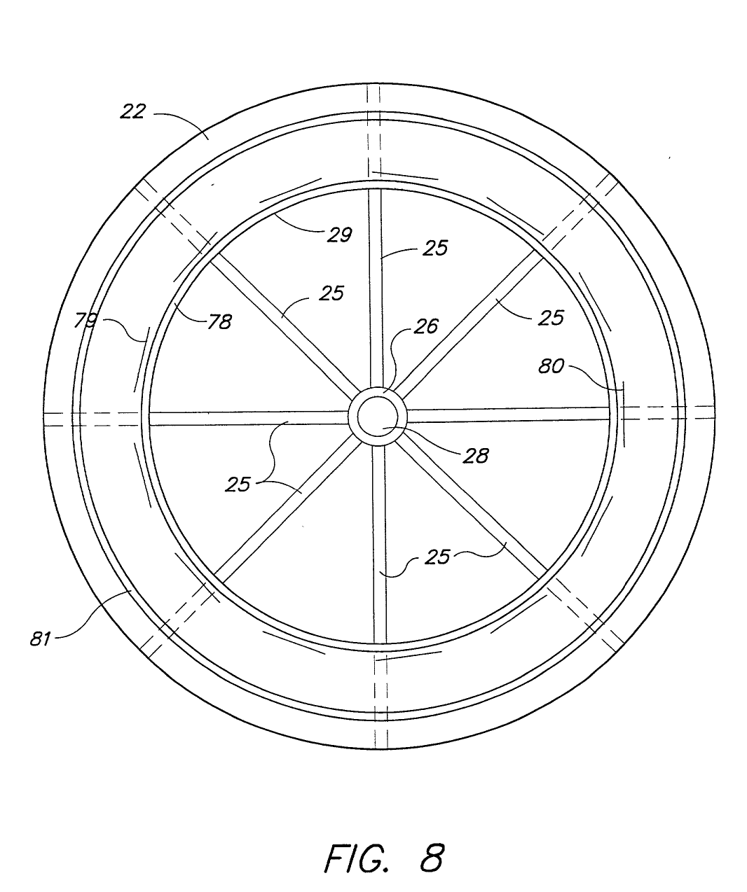

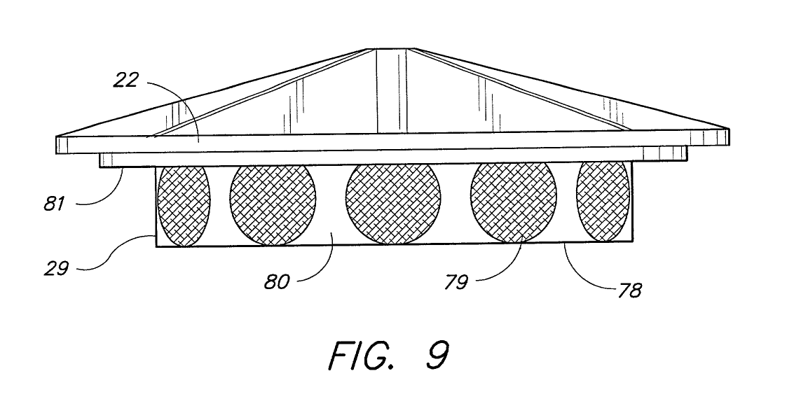

Referring to FIGS. 1 and 2 there is shown a perspective view and a plan view, respectively, of the inventive flywheel battery electrical vehicle system 10, excluding the flywheel, having flywheel motor housing 12, having in turn cylindrical housing wall 14, having upper edge 16 and lower edge 18, housing motor mounts 20 located at 90 degree intervals along lower edge 18, and motor mount bracing flanges 21 extending upward along cylindrical housing wall 14. Housing cover 22 features planar housing cover 23 extending along the cylindrical housing wall upper edge 16 and is connected to upper housing axial rotary bearing 26 by upper supporting flanges 24 and lower supporting flanges 25. Upper housing axial bearing 28 is located at the upper end of upper housing axial rotary bearing 26. Upper housing mounts (not shown) extend outwardly from housing planar cover 23 and are located around cylindrical housing wall 14 at 90 degree intervals, and are aligned with housing motor mounts 20. As seen in FIG. 2, housing axial lower bearing 32 is aligned with upper housing axial rotary bearing 26 and is supported by lower housing bottom 34, formed by triangular plates 35. Depending wall 29 extends downward from planar housing cover 23 (see FIGS. 8 and 9)

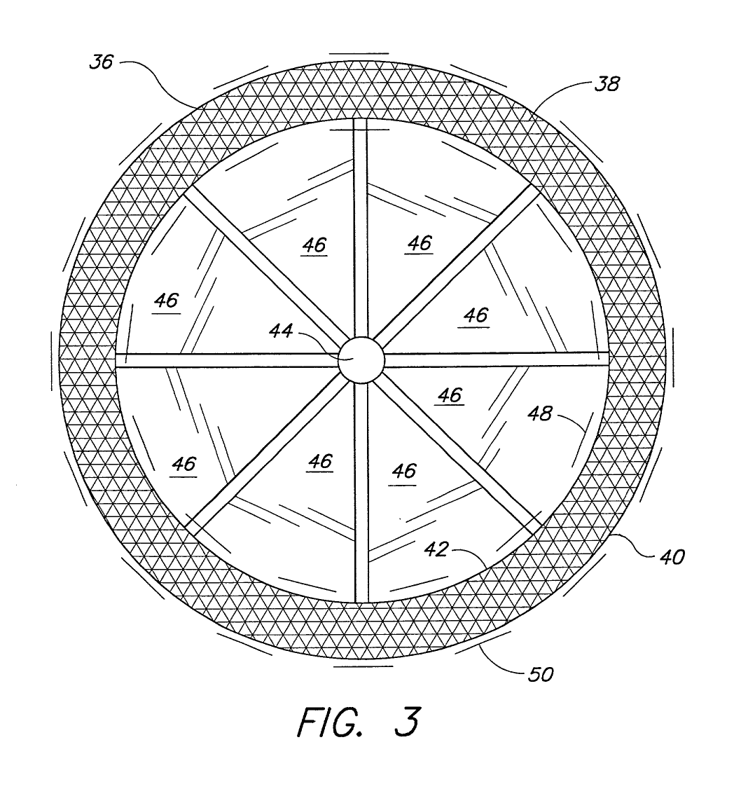

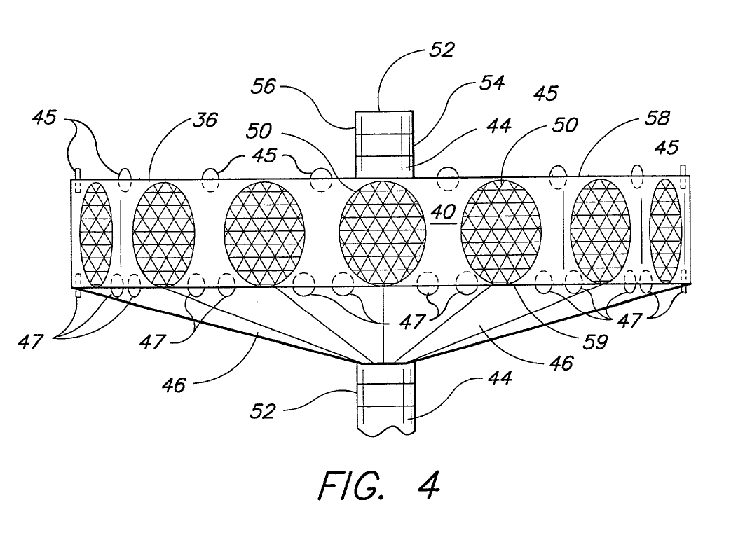

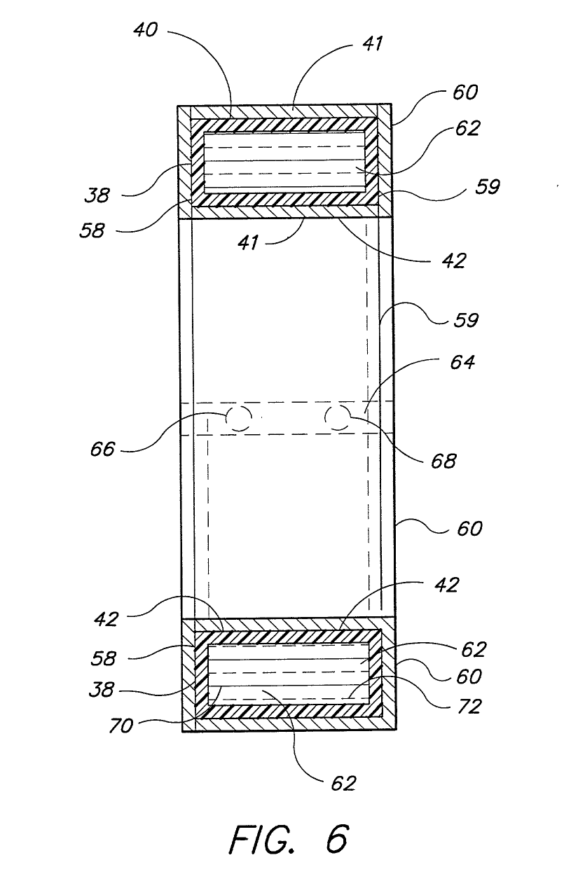

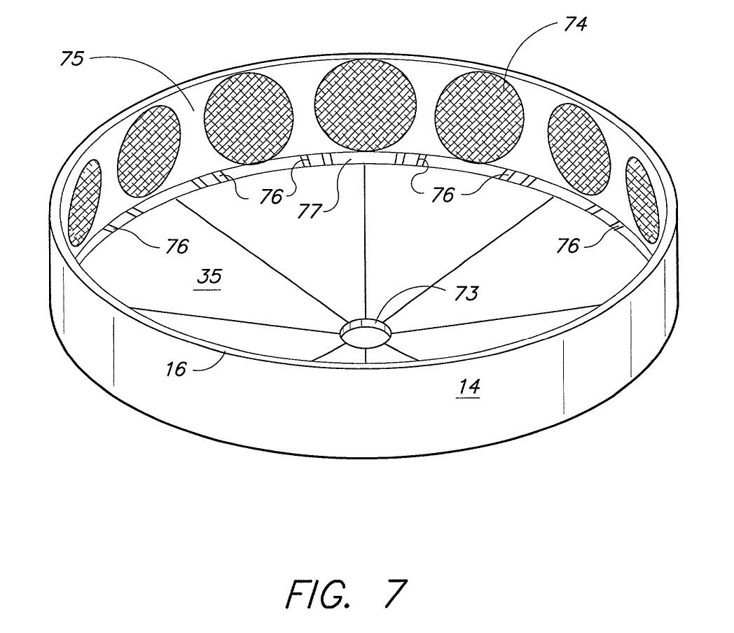

Referring to FIGS. 3 through 6, there is shown a plan view and an elevation view, respectively, of the flywheel rotary battery assembly 36, and a plan view and sectional view along lines 6-6 of peripheral battery 38 with battery cover 41. Peripheral battery 38 features battery casing outer wall 40 and battery casing inner wall 42. Battery cover 41 encloses peripheral battery 38 and assures attachment and correct positioning of peripheral battery 38. Stabilizing bearings 45 are located around the periphery of battery cover 41 and run in stabilizer track 81 located on the underside of planar housing cover 23 (see FIGS. 8 and 9). Contact bearing pairs 47 are located at the periphery of peripheral battery support 60 and make periodic electrical contact with rotor coil bearing contact pairs 76 located in contact track 77 (see FIG. 7) as rotary battery assembly 36 rotates. Axially located axle 44 is connected with a peripheral battery support 60 (see FIG. 6) supporting peripheral battery 38, by means of angled rotor braces 46, so configured as to act as a cooling fan upon rotation of rotor battery assembly 36. Inner rotor windings 48 are located along the battery casing inner wall 42 of peripheral battery 38 and outer rotor windings 50 are located along the outer wall 40 of peripheral battery 38. They are electrically connected for activation with drive/charge computer through a wiring harness (not shown) which connects with axle 44 and individual brushes leading from axle 44 to the drive/charge computer. As shown in FIG. 4, rotary battery assembly 36 drives axle 44 which is the mechanical output of the flywheel battery electrical vehicle system 10, which is connected to an appropriate hydraulic transmission (not shown). Axle 44 features main battery positive contact 54 and main battery negative contact 56 for brushes (not shown) connected to the drive/charge control computer, for input and output of electrical power to FBEV motor system 10. Peripheral battery 38 is further contained by upper wall 58 and lower wall 59.

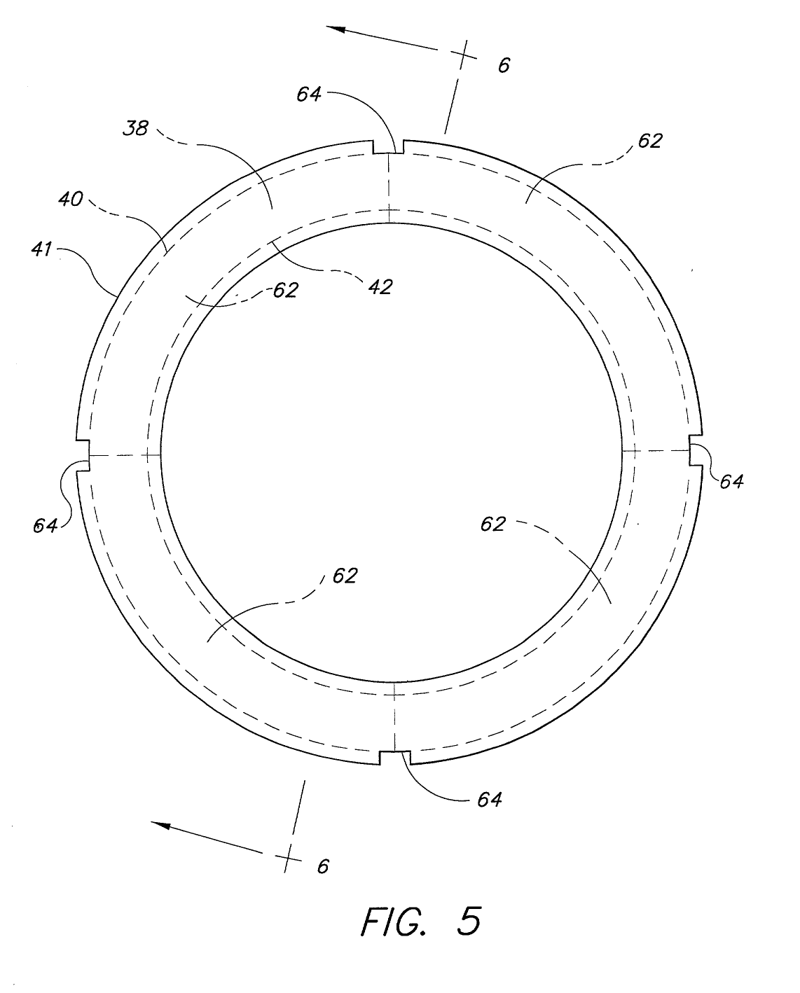

Referring more particularly to FIGS. 5 and 6, there is shown starved electrolyte lead acid peripheral battery 38 encased within battery cover 41 and having outer wall 40, inner wall 42, having upper wall 58, and lower wall 59, each wall preferably made of molded plastic. Peripheral battery 38 may be a single cell or divided into a plurality of cells, four cells 62 being shown, having battery mounting notches 64 located at 90 degree intervals along battery casing outer wall 40, each mounting notch having a battery positive terminal 66, and a battery negative terminal 68, and each being connected to respective main battery contacts 54 and 56 by appropriate circuitry (not shown). Peripheral battery 38 is also held in place by mechanical uprights (not shown) projecting upward from peripheral battery support 60 and serve as connectors to positive terminals 66 and negative terminals 68. A depiction of mounting notches and terminals 66 and 68 (see FIG. 6) are shown to illustrate their physical location relative to peripheral battery wall 40. The starved electrolyte lead acid battery 38 consists of starved electrolyte paste between lead-copper plates of the battery to accommodate the high RPM that the battery will be spinning. Alternating battery positive plates 70 and battery negative plates 72 form alternate coaxial cylinders within the peripheral battery in the case of a single cell embodiment of the peripheral battery 38, and partial alternate coaxial cylinders within the peripheral battery 38 in the case of multiple cells. Conventional battery design will not permit this type of movement because the liquid electrolyte would be pushed out by centrifugal force.

Referring to FIG. 7, there is shown a perspective view of cylindrical housing wall 14 with housing cover 22 and rotary battery system 36 removed, showing lower central axle aperture 73 formed collectively by triangular plates 35 at their lower intersection. Individual triangular plates 35 have apertures therethrough (not shown) which allow the passage of cooling air through FBEV system 10. Outer stator windings 74 are located along cylindrical housing inner wall 75. Rotor coil bearing contact pairs 76 are located in contact track 77 located at the base of cylindrical housing inner wall 75.

Referring to FIGS. 8 and 9 there are shown a bottom view and an elevation view, respectively, of the stator housing top assembly, where housing cover 22 has axial rotary bearing 26 and axial bearing end cap 28 centrally located therein and features coaxial depending wall 77 ending at lower edge 78, and bearing inner stator windings 79 around its outer wall 80. Stabilizer track 81 is located on the underside of housing cover 22 and provides a race for stabilizer bearings 45 (see FIG. 4). Apertures (not shown) are located in housing planar cover 23 between coaxial depending wall 77 and axle port 76 to allow cooling air to flow through the flywheel motor housing 12.

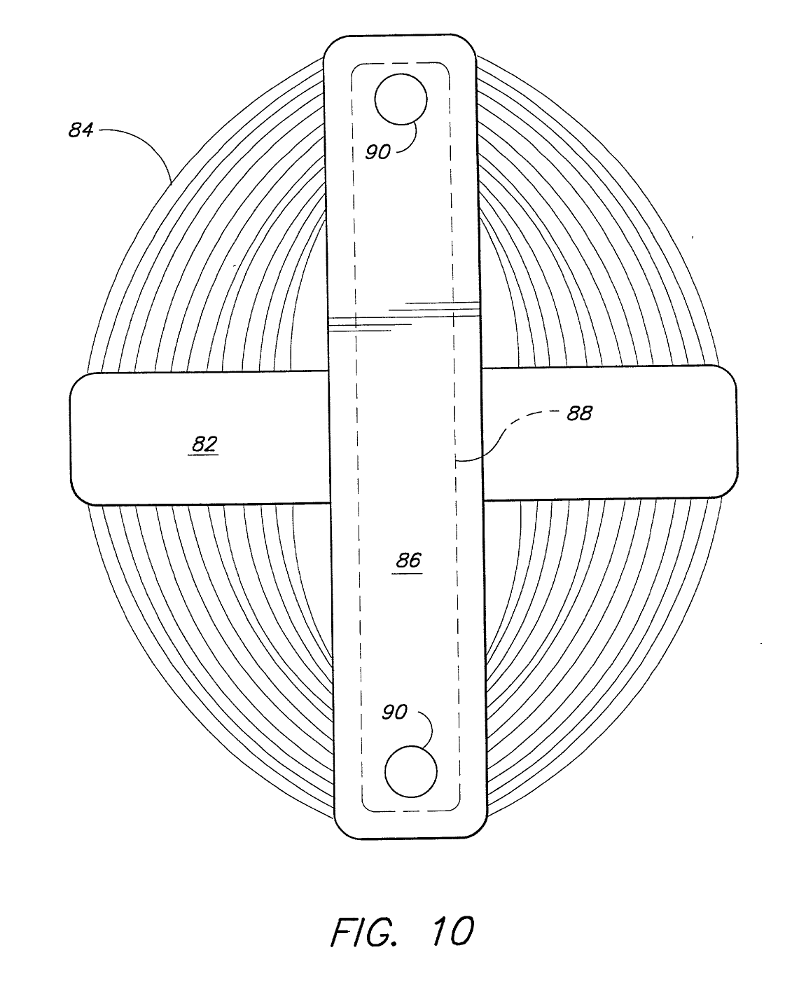

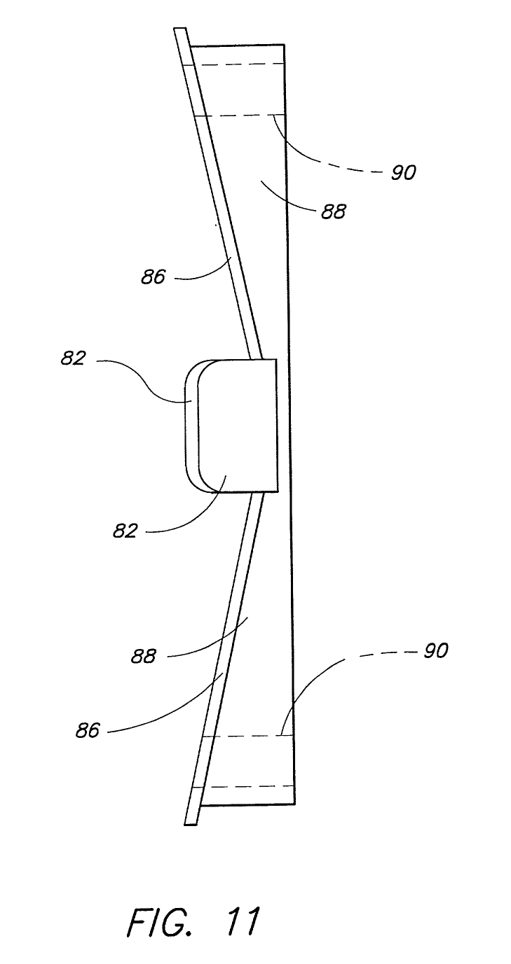

Referring to FIGS. 10 and 11 there are shown a front elevation view and a side elevation view (absent windings), respectively. Each outer rotor winding 50 (see FIG. 4) comprises horizontal cleat portion 82 and vertical cleat portion 86 supporting electrical wire coil winding 84 around electromagnet 88 by means of fasteners 90. Horizontal cleat portion 82, vertical cleat portion 86, and electromagnet 88 may be of any suitable electromagnetic material, preferably steel, and may be an integral element. The structure of stator windings 50 are representative of all the stator and rotor windings of FBEV system 10.

In operation, upon initial startup of FBEV system 10, it is preferable that the FBEV motor still be attached to a charge station via a charge cord (not shown), thereby using an outside power source to start the motor, rather than using the vehicle's battery. The charge station provides conditioned 240-volt power for deep cycle charge. The charge cord, however, comes with an optional adaptor so that a 110 volt receptacle can be used for supplemental charging. The drive/charge control computer (not shown) senses voltage differences and charges the battery accordingly.

This initial startup can be done from the vehicle, itself, or from a remote control device. The remote control allows the operator to turn on the vehicle while he is still preparing to leave. The vehicle will be warmed up and ready for operation by the time he enters the vehicle.

Once operating RPM is attained (approximately 3600 RPM), a ready light on the vehicle's dashboard (not shown) changes from red to green, telling the operator the vehicle is ready to drive. This will take approximately three minutes.

Due to the weight of the flywheel, any time the motor is in an off/stop position, it requires a start-up/warm-up time of about three minutes.

During the warm-up period, the drive/charge control computer (not shown) activates some, but not all of the coils with pulsating current to start the flywheel in motion to conserve battery power when start-up is done away from the charge station. The field windings 74 and 79 are energized through sets of parallel contact bearings 47, mounted around the circumference of the lower part of the housing 12. Stabilizing bearings 45 and stabilizing bearing track 43 provide mechanical stability to the rotating rotary battery assembly. The housing cover 22 and lower housing 34 contain stabilizing track 43 and contact track 77, respectively, each preferable made of Teflon® that the bearings ride on. Contact bearings 47 ride in contact track 77 having conductive contacts 76 set in pairs in specific locations to energize the field windings as desired and so located as to correspond with the bearings. Direct current is selectively supplied to these contact pairs through a wiring harness (not shown) from the drive/charge computer.

The rotor windings 48 and 50 of the rotary battery assembly 36 are selectively energized by the drive/charge computer using battery power or outside power by means of conductive brushes (not shown) on axle 44 along with the main battery contacts 54 and 56. This allows constant current to flow to and from the battery and the rotor coil windings.

Once operating RPM is attained, the charge/drive control computer keeps the motor operating at an RPM between about 3600 and 4600 by energizing or de-energizing rotor windings and field windings as needed. There is a series of sensors and meters (not shown) that determine the speed of the vehicle to motor RPM ratio. If the vehicle is moving faster than the flywheel's potential power, for example during coasting, slowing down or going down-hill, these sensors and meters signal the drive/charge control computer that it is in a charge condition and the rotor windings 48 and 50 will become excitation windings by means of direct current supplied by brushes on the axle 44 to turn the stator windings 74 and 79 into power generating condition to charge the battery 38 by means of the wiring harness and the drive/charge computer.

During operation on battery power, the battery's current leaves the battery through main battery contacts 54 and 56 on the rotor's axle, goes through engaging brushes into the charge/drive control computer, which then transfers the current as needed through brushes on the axle to selected rotor windings and through a wiring harness to selected contact pairs to various field windings. Field windings 74 and 79 are provided with momentary electrical current through contact bearings 47 making momentary contact with rotor coil bearing contacts selectively energized by the computer, forming collapsing magnetic fields which interact with rotor windings 48 and 50 to form an electric motor. During operation, the motor is cooled by airflow caused by the rotor braces 46 being offset to create a fan-like environment and the upper housing 22 and lower housing 34 are louvered (not shown) to permit airflow.

Upon shutdown, two conditions apply. When shutdown takes place away from charge stations, the momentum of the peripheral battery assembly 36 is used to charge the battery 38 until its momentum stops and shutdown is complete. When shutdown occurs at a charge station, the charge cord will supply charge current to the battery 38. Then the rotary battery assembly 36 will just spin freely until it slows down and stops.

It is to be understood that the present invention is not limited to the embodiments described above, but encompasses any and all embodiments within the scope of the following claims.

I claim:

1. An integrated flywheel operated battery and motor for employment in a flywheel battery electric vehicle comprising:
a) a horizontally disposed cylindrical housing having an inverted conical base and a removable disc-shaped cover;
b) a horizontally disposed flywheel disposed in said housing for rotation about a rotatable axle;
c) a circular battery located about the periphery of said flywheel;
d) said circular battery having a casing having an inner vertical wall and an outer vertical wall;
e) first electromagnets, said battery casing having a plurality of rotor windings, each being wrapped around a said first electromagnet and mounted at spaced intervals along said inner wall and said outer wall;
d) said cylindrical housing having an axially disposed bearing within said cover for receiving said rotatable axle;
e) said housing conical base defining an aperture through the center thereof through which said axle projects;
f) said housing having an outer cylindrical wall having an inner side;
g) second electromagnets, said housing inner side having a plurality of field windings, each being wrapped around a said second electromagnet and mounted and equally spaced around the circumference of said wall inner side;
h) said housing cover having a depending cylindrical wall disposed coaxially immediately inside said battery casing wall and having a plurality of field coils mounted and equally spaced along an outer side of said depending wall;
i) a plurality of electrical brush locations along said axle, each corresponding to an individual said rotor winding, brush means for conducting electricity from said computer to said brush locations, and means within said axle for conducting electricity from each of said plurality of brush locations to said individual rotor windings;
j) a pair of primary electrical brush locations along said axle electrically connected to corresponding positive and negative poles of said battery, and brush means to conduct electricity from said primary brush locations to and from said computer;
k) means for constant electrically connecting said individual field coils with said computer under charge conditions; and
l) means for selective intermittent electrical connection of said individual field coils with said computer under motor drive conditions;
whereby, when under a condition of load, said computer directs a constant flow of electricity from said battery to a selected number of said rotor windings, and an intermittent flow of electricity to said field windings to act as a drive motor, and whereby under a condition of charging said computer directs a constant flow of electricity to said rotor windings, and receives a constant flow of electricity from said field coils, which is conducted to said battery for charging under charge conditions.

2. The integrated flywheel battery and motor according to claim 1, further including means connected with said computer for conducting electricity from a remote source to said battery for charging and for bringing said flywheel up to operating speed for starting the flywheel battery electric vehicle.
